(19) United States
(12) Patent Application Publication
(10) Pub. No.: US 2026/0254837 A1
(43) Pub. Date: Aug. 27, 2026

(54) PREDICTIVE DISTRIBUTED DENIAL OF SERVICE VULNERABILITY IDENTIFICATION FOR PRODUCTION ENVIRONMENTS

(71) Applicant: MAZEBOLT TECHNOLOGIES LTD., Ramat Gan (IL)

(72) Inventors: Matthew ANDRIANI, Hod Hasharon (IL); Ron WEINER, Ramat Gan (IL)

(73) Assignee: MAZEBOLT TECHNOLOGIES LTD., Ramat Gan (IL)

(21) Appl. No.: 19/489,680

(22) PCT Filed: Jun. 6, 2024
(86) PCT No.: PCT/IB2024/055550

§ 371 Date: Dec. 3, 2025

Related U.S. Application Data
(60) Provisional application No. 63/508,003, filed on Jun. 14, 2023.

(51) Int. Cl. H04L 9/40; G06N 20/00

(52) U.S. Cl. CPC H04L 63/1433; G06N 20/00; H04L 63/1458

(57) ABSTRACT

In one embodiment, a computer-implemented method includes obtaining Non-Disruptive DDOS (NDDDOS) testing result data and training a computerized model with the Non-Disruptive DDOS testing result data to predict DDOS vulnerability of a production element. In another embodiment, a computer-implemented method includes accessing, by at least one processor, a computerized model, trained to predict DDOS vulnerability of a production element, deploying the trained model by the at least one processor, inputting environmental data of the production element into the trained model, and receiving an indication of vulnerability of the production element to DDOS from the trained model. Other systems and methods are included.

### RELATED APPLICATION INFORMATION

The present application claims benefit of U.S. Provisional Patent Application Ser. No. 63/508,003, entitled “Predictive distributed denial of service vulnerability identification for production environments”, of Andriani, et al., filed 14 Jun. 2023, the disclosure of which is hereby incorporated herein by reference herein in its entirety.

### FIELD OF THE DISCLOSURE

The present disclosure relates to computer systems, and in particular, but not exclusively to, security in computer systems.

### BACKGROUND

Distributed denial of service (DDOS) attacks are cyber-attacks originating from public networks such as the Internet, and are a major threat to financial institutions (e.g., banks, Forex trading, stock exchanges), large e-commerce sites (auctions, gaming, retail, travel, gambling), hospitals, cloud infrastructure, governmental sites, ISP infrastructure, national infrastructure, and other organizations. Such attacks can bring down servers or services, prevent communications, stop business continuity, or otherwise damage enterprise networks such as those of stock exchanges, banks, governments, voting sites, insurance companies, NGOs (non-governmental organizations), as well as other critical online infrastructure. Despite increases in DDoS protection, most organizations, including the aforementioned entities and organizations, remain highly vulnerable to such cyber-attacks and lack little if any knowledge of the extent of their vulnerability to such cyber-attacks.

### SUMMARY

There is provided in accordance with an embodiment of the present disclosure, a computer-implemented method, including obtaining Non-Disruptive DDoS (NDDDOS) testing result data, and training a computerized model with the Non-Disruptive DDoS testing result data to predict DDOS vulnerability of a production element.

Further in accordance with an embodiment of the present disclosure the training includes training the computerized model using any one or more of the following machine learning, artificial intelligence, supervised learning, unsupervised learning, reinforcement learning.

Still further in accordance with an embodiment of the present disclosure the training includes training the computerized model with the NDDDOS testing result data to predict DDoS vulnerability of the production element based on environmental data of the production element.

Additionally in accordance with an embodiment of the present disclosure the environmental data of the production element includes data about at least one DDOS protection layer used to protect the production element.

Moreover, in accordance with an embodiment of the present disclosure, the method includes anonymizing the NDDDOS testing result data.

Further in accordance with an embodiment of the present disclosure, the method includes anonymizing the NDDDOS testing result data to remove entity identification data while retaining industry identification data.

Still further in accordance with an embodiment of the present disclosure the production element includes any one or more of the following a production target, a production service, a production component, or a production environment.

Additionally in accordance with an embodiment of the present disclosure the obtained NDDDOS testing result data includes any one or more of a vulnerability status, a protected status, or a varying degree of vulnerability.

Moreover, in accordance with an embodiment of the present disclosure the NDDDOS testing result data includes DDOS-protected points.

Further in accordance with an embodiment of the present disclosure the training includes training the computerized model with the NDDDOS testing result data to predict a DDoS vulnerability level of the production element.

There is also provided in accordance with still another embodiment of the present disclosure a computer-implemented method, including obtaining data from any one or more of the following Non-Disruptive DDoS testing, disruptive DDoS testing, confirmed DDoS attack logs, or production originating vulnerability data, and training a computerized model with the obtained data to predict DDoS vulnerability of a production element.

Still further in accordance with an embodiment of the present disclosure the production element includes any one or more of the following a production target, a production service, a production component, or a production environment.

Additionally in accordance with an embodiment of the present disclosure the training includes training the computerized model with the obtained data to predict a DDoS vulnerability level of the production element.

There is also provided in accordance with another embodiment of the present disclosure, a computer-implemented method, including accessing, by at least one processor, a computerized model, trained to predict DDoS vulnerability of a production element, deploying the trained model by the at least one processor, inputting environmental data of the production element into the trained model, and receiving an indication of vulnerability of the production element to DDoS from the trained model.

Moreover, in accordance with an embodiment of the present disclosure the computerized model is trained with Non-Disruptive DDoS testing result data to predict DDoS vulnerability of the production element.

Further in accordance with an embodiment of the present disclosure the NDDDOS testing result data includes DDoS-protected points.

Still further in accordance with an embodiment of the present disclosure the environmental data includes a given set of data from Non-Disruptive DDoS (NDDDOS) testing results.

Additionally in accordance with an embodiment of the present disclosure the NDDDOS testing results include parameters including any one or more of the following a response time, a leakage rate and volume on service, a leakage rate and volume on environment, or a number and rate of blocked requests.

Moreover, in accordance with an embodiment of the present disclosure the environmental data of the production element includes data about at least one DDOS protection layer used to protect the production element.

Further in accordance with an embodiment of the present disclosure the environmental data of the production element is derived from any one or more of the following Non-Disruptive DDoS (NDDDOS) testing, disruptive DDoS testing, DDOS vulnerability data, and/or Open-Source Intelligence (OSINT).

Still further in accordance with an embodiment of the present disclosure the production element includes any one or more of the following a production target, a production service, a production component, or a production environment.

Additionally in accordance with an embodiment of the present disclosure the indication of vulnerability includes any one or more of the following a vulnerability status, a protected status, or a varying degree of vulnerability.

There is also provided in accordance with still another embodiment of the present disclosure a system, including at least one processor configured to obtain Non-Disruptive DDoS (NDDDOS) testing result data, and train a computerized model with the Non-Disruptive DDoS testing result data to predict DDoS vulnerability of a production element, and at least one memory configured to store data used by the at least one processor.

There is also provided in accordance with still another embodiment of the present disclosure a system, including at least one processor configured to obtain data from any one or more of the following Non-Disruptive DDoS testing, disruptive DDoS testing, confirmed DDoS attack logs, or production originating vulnerability data, and train a computerized model with the obtained data to predict DDoS vulnerability of a production element, and at least one memory configured to store data used by the at least one processor.

There is also provided in accordance with still another embodiment of the present disclosure a system, including at least one processor configured to access a computerized model trained to predict DDoS vulnerability of a production element, deploy the trained model, input environmental data of the production element into the trained model, and receive an indication of vulnerability of the production element to DDoS from the trained model, and at least one memory configured to store data used by the at least one processor.

### BRIEF DESCRIPTION OF THE DRAWINGS

The present disclosure will be understood from the following detailed description, taken in conjunction with the drawings in which:

FIG. 1 is a block diagram view of a DDOS vulnerability prediction model training system constructed and operative in accordance with an embodiment of the present disclosure;

FIG. 2 is a flowchart including steps in a method of operation of the DDOS vulnerability prediction model training system of FIG. 1;

FIG. 3 is a block diagram view of a DDOS vulnerability prediction system constructed and operative in accordance with an embodiment of the present disclosure;

FIG. 4 is a flowchart including steps in a method of operation of the DDOS vulnerability prediction system of FIG. 3;

FIG. 5 is a schematic view of an example classification model implemented with a deep neural network for use in the systems of FIGS. 1 and 3;

FIG. 6 is a schematic view of an example of deep reinforcement learning model for Non-Disruptive testing system schedulers for use in the systems of FIGS. 1 and 3;

FIG. 7 is schematic view of an example statistical model for vulnerability assessment for use in the systems of FIGS. 1 and 3;

FIG. 8 is a schematic view of an example unsupervised model for performing a service vulnerability assessment task in the systems of FIGS. 1 and 3; and

FIG. 9 is a block diagram view of an example mode of operation of the systems of FIGS. 1 and 3.

### DETAILED DESCRIPTION

### Overview

To determine vulnerabilities of a target and/or service to DDoS, it has been necessary to launch one or more DDoS attacks in a maintenance window and observe the effects of the DDoS attack(s). This method has drawbacks. First, the system under investigation needs to be down (i.e., not in production mode). Second, the number of test attacks which may be launched in a maintenance window is extremely limited. Third, maintenance windows can only generally be scheduled occasionally due to operational factors.

One solution to determine vulnerabilities of a target or service to DDoS is to evaluate the target or service in production mode (without having to use a maintenance window) using a Non-Disruptive DDOS vulnerability system commercially available from Mazebolt Technologies Ltd. and described in U.S. Pat. No. 10,509,909 entitled “Non-Disruptive DDoS Testing” and PCT Publication WO 2023/057950, entitled “Non-disruptive diagnostic and attack testing methods and systems”, filed on Oct. 6, 2022, both of the disclosures of which are incorporated herein by reference in their entirety. These present methods may be used to provide Non-Disruptive DDOS testing data, which indicate for targets and/or services in a given environment, whether the targets and/or services are vulnerable (or how vulnerable) to given DDOS attacks (e.g., attack vectors). However, these Non-Disruptive DDOS vulnerability systems are limited in that they need to be installed in the target environment and perform the evaluations over a period of time.

### I. Detailed Description of Example Embodiments

Embodiments of the present disclosure improve and overcome the limitation of having to install components in the target production environment to gain DDoS vulnerability insight. The embodiments of the present disclosure function by obtaining Non-Disruptive DDoS (NDDDOS) testing result data (e.g., from applying the Non-Disruptive DDOS vulnerability system commercially available from Mazebolt Technologies Ltd. to different production systems), and optionally obtaining other data from sources such as disruptive DDoS testing data, confirmed DDoS attack logs, and production originating vulnerability data, and using the obtained data to train a computerized model to predict DDoS vulnerability of a production element or elements (e.g., a production target, a production service, a production component, or a production environment). The model may be trained using any suitable technique, for example, using machine learning (ML), artificial intelligence (AI), supervised learning, unsupervised learning, or reinforcement learning.

In some embodiments, the obtained data is anonymized to remove entity specific (e.g., company specific) data. Industry identification data (e.g., banking, insurance, manufacturing) is generally retained. The obtained data may also include such data as (DDoS) security layers in place in each production system, the vulnerability of the targets/services to different attack vectors in each production system, and the services (e.g., port numbers, web service, VPN service, DNS service) found in each production system.

A given production environment or a portion thereof may then be evaluated using the trained model. Environmental data (such as (DDoS) security layers in place, and/or online service/s used, and/or location of target, and/or FQDN (Fully Qualified Domain Name) or IP (Internet Protocol) address, and/or port of service) of the given production environment is inputted to the trained model. The trained model provides an output which provides a prediction of DDoS vulnerability of targets and/or services in the production environment in general and/or to one or more given DDoS attack vectors. The term “DDoS vulnerability”, may mean (a) DDoS vulnerability/vulnerabilities of a specific target, e.g., Target X is vulnerable to attack vector Y and Z on port 80 or (b) a rating, e.g. production environment X is 54% vulnerable. That is to say that the term “DDoS vulnerability” may be specific or broad, but quantifies vulnerability/vulnerabilities for a specific scenario. Such vulnerability data may be output to provide specific information to remediate a vulnerability identified, e.g., mazebolt.com+SYN Flood+port 80=Vulnerable. Using this data, a mitigation vendor could patch the SYN flood vulnerability. Some of the environmental data may be discovered (e.g., using open-source intelligence) and confirmed by the system administrator of the given production environment. Some, or all, of the environmental data may be provided by the system administrator of the given production environment.

Therefore, embodiments of the present disclosure use various models to predict the likelihood of DDoS attack vulnerabilities in live production environments, for example, without the need to deploy or otherwise install an active DDoS testing vulnerability system, such as those systems described in U.S. Pat. No. 10,509,909 and PCT Publication WO 2023/057950.

Data used in the disclosed subject matter, for example, in training the various models, and as input for given instances into the models may include data acquired from Non-Disruptive DDoS testing, for example, as obtained from U.S. Pat. No. 10,509,909 and PCT Publication WO 2023/057950. The data obtained from simulated attacks on a production network may be used to train models to predict, for example, DDoS vulnerabilities, using meta-data inputs about the targeted environment, and, for example, without the need for a full deployment or active testing of the production environment.

As more data becomes available over time, this additional attack and vulnerability data, optionally in addition to data from testing systems such as U.S. Pat. No. 10,509,909 and PCT Publication WO 2023/057950, confirmed mitigation of DDoS attacks through sources such as logs, Disruptive DDoS testing, red team DDoS testing, and the like, of reliable confirmed DDoS vulnerability data, may be usable with the disclosed models, to analyze vulnerability in networks and/or online services, including production networks.

Documents incorporated by reference herein are to be considered an integral part of the application except that, to the extent that any terms are defined in these incorporated documents in a manner that conflicts with definitions made explicitly or implicitly in the present specification, only the definitions in the present specification should be considered.

### Aspects of the Disclosure

1.0. Production originating DDoS vulnerability data gathered from any type of Non-Disruptive (ND) DDoS testing method, may be used in a statistical model and/or ML (Machine Learning) and/or AI (Artificial Intelligence) model.
1.1. Optionally, according to aspect 1.0, wherein the machine learning model is based on supervised learning.
1.2. Optionally, according to aspect 1.0 or aspect 1.1, the machine learning model is based on un-supervised learning.
1.3. Optionally, according to any one of aspects 1.0 to 1.2, the machine learning model is based on reinforcement learning.
1.4. Optionally, according to any one of aspects 1.0 to 1.3, the statistical model is used for inference or prediction utilizing the gathered data of NDDDOS testing from the RADAR™ product commercially available from Mazebolt Technologies Ltd. of Israel.
1.5. Optionally, according to any one of aspects 1.0 to 1.4, the result of the machine learning model may be applied to a Non-Disruptive testing system scheduler to evaluate the targets more efficiently, so such systems evaluation time is reduced.
1.6. Optionally, according to any one of aspects 1.0 to 1.5, the result of the machine learning model allows a DDOS vulnerability or protection status to be predicted for a given target, where the given target includes at least one of the following: Internet Protocol (IP), Fully Qualified Domain Name (FQDN), service, or network
1.7. Optionally, according to any one of aspects 1.0 to 1.6, the result of the machine learning model may be used for DDOS threat scoring in accordance with the environment (e.g., company, environment, service) or specific target being evaluated.
1.8. Optionally, according to any one of aspects 1.0 to 1.7, the result of the machine learning model detects the vulnerable defense components of an environment.
1.9. Optionally, according to any one of aspects 1.0 to 1.8, the result of the machine learning model detects possible attack vector combinations according to their likelihood of penetrating the evaluated environment.
1.10. Optionally, according to any one of aspects 1.0 to 1.9, the result of the machine learning model detects the thresholds for an attack and/or attacks that enable the successful penetration or protection of an environment.
1.11. Optionally, according to any one of aspects 1.0 to Aspect 1.10, Open-Source Intelligence (OSINT) may identify independently and/or based on user input data, target IPs and/or fully qualified domain names (FQDNs) and/or ports and/or services to be input into the machine learning model.
1.12. Optionally, according to any one of aspects 1.0 to 1.11, a result is attained from the system, and the result is applied to a product feature (e.g., used in a feature to provide more effective simulation selections for any obtained non-predictive product).
1.13. Optionally, according to any one of aspects 1.0 to 1.12, a result is obtained from the system, and the result is applied or utilized by a third party and/or API interface.
1.14. Optionally, according to any one of aspects 1.0 to 1.13, originating DDOS vulnerability data and/or response monitoring data includes big data from other production environment sources.
2.0. Production originating DDoS vulnerability data may be gathered from traditional DDoS testing, and/or any type of Non-Disruptive DDOS testing methods being used in a statistical model and/or ML (Machine Learning) and/or AI (Artificial Intelligence) models.
2.1. Optionally, according to aspect 2.0, the machine learning model is based on supervised learning.
2.2. Optionally, according to aspect 2.0 or aspect 2.1, the machine learning model is based on unsupervised learning.
2.3. Optionally, according to any one of aspects 2.0 to 2.2, the machine learning model is based on reinforcement learning.
2.4. Optionally, according to any one of aspects 2.0 to Aspect 2.3, the statistical models use data collected by tests in multiple systems and statistical assumptions for inference or prediction.
2.5. Optionally, according to any one of aspects 2.0 to 2.4, originating DDoS vulnerability data and/or response monitoring data includes big data from other production environment sources.
3.0 Production originating DDoS vulnerability data, which is gathered from any type of confirmed successful or unsuccessful DDoS attack event, and/or traditional DDoS testing, and/or any type of Non-Disruptive DDOS testing methods, may be used in a statistical model and/or ML (Machine Learning) and/or AI (Artificial Intelligence) models.
3.1. Optionally, according to aspect 3.0, the machine learning model is based on supervised learning.
3.2. Optionally, according to aspect 3.0 or aspect 3.1, the machine learning model is based on unsupervised learning.
3.3. Optionally, according to any one of aspects 3.0 to 3.2, the machine learning model is based on reinforcement learning.
3.4. Optionally, according to any one of aspects 3.0 to 3.3, the statistical models use the data collected by system tests together with statistical assumptions for inference or prediction.
3.5. Optionally, according to any one of aspects 3.0 to 3.4, originating DDoS vulnerability data and/or response monitoring data is big data from other production environment sources.

### Terminology

Reference to the following terminology is made in the specification and claims in various grammatical forms.

“Production originating” may include real Information Technology (IT) Production environments (also known as Production Networks), live environments serving commercial, governmental, or other organization needs, but typically not quality assurance (QA) labs or staging environments. The production environments may be, for example, hosted on the cloud, infrastructure, or other locations.

“Non-Disruptive DDOS (ND-DDOS or NDDDOS) testing” may include testing of production systems for DDOS vulnerabilities or weaknesses that does not require a maintenance period, for example, as described in the production networks of U.S. Pat. No. 10,509,909 and PCT Publication WO 2023/057950, the disclosures of which are incorporated by reference herein. Additionally, any other testing which identifies DDoS weaknesses in production environments without the requirement for a maintenance window or downtime of the production environment is also suitable for Non-Disruptive DDoS Testing. This method of DDoS testing may be performed on a production network without causing any disruption to the tested production network. Examples of such Non-Disruptive DDoS testing include those detailed in U.S. Pat. No. 10,509,909 and PCT Publication WO 2023/057950. One characteristic of Non-Disruptive DDoS testing is the ability to launch a large number of DDoS attacks over a given time period of lengths such as, days, weeks, months, or years without affecting production services. This allows for thousands of simulations to be performed, allowing big data to be gathered on the vulnerability level of the environment being evaluated. Prior to the advent of Non-Disruptive DDoS testing, as disclosed in the aforementioned patent documents, it was not possible to practically check the DDoS attack surface of an organization in production, or gather such large amounts of DDoS vulnerability data points, since traditional testing (sometimes referred to as DDoS testing or red team testing) methods cause downtime to production environments and a maintenance window is required by organizations, limiting the amount of such testing and very little coverage of the DDoS attack surface, meaning very few DDoS vulnerability data points. This made it impossible or impractical to confirm DDoS vulnerability through big data, AI, machine learning (ML), or other statistical models.

“Open-source intelligence (OSINT)” may include the collection and analysis of data gathered from open sources (covert and publicly available sources) to produce actionable intelligence. OSINT sources may be divided up into six categories of information flow: media, Internet, public government data, professional and academic publications, commercial data, and grey literature.

“Production Target” (also known as a target) may include a point that could be attacked on a production network, typically and FQDN (fully qualified domain name) or IP (Internet Protocol) address. Some examples of targets are 184.23.44.2 or 8.8.8.8 or www.mazebolt.com or mazebolt.com. A target may also be a combination of address, such as IP, or FQDN name, and a port. For example, some targets with an address and a port are: www.mazebolt.com: 443, or 8.8.8.8:53, or 184.23.44.2:80. The port is specified after the “:”in the examples.

“Production service” (also known as a service) may include a target having a port open on them and this port usually has a service that it connects to, for example Web service, VPN service, FTP, API, SMTP, POP, NTP, BGP, Mobile application (app) service, DNS service, etc. Services can be hosted on multiple technologies and platforms, such as cloud, datacenters, dockers, lambda instances, virtual services and the like.

“DDoS-protected point” may include a reference to a target that has had an attack simulation against it and has proven to be not vulnerable, i.e., protected. For example, Vulnerability check (Target=www.mazebolt.com, attack vector=HULK, port=443, rate=4000CPS, time_to_run_attack=2 mins). The potential expected attack traffic leakage could be 480,000 connections leakage (120 seconds×4000 CPS), and in this example it is assumed that only 4000 connections leaked, and the system considers this leakage to be “Protected”.

“DDoS Security component” may include any of the following: a scrubbing center, CPE (Customer Premise Equipment), CDN (Content delivery network), WAF (Web Application Firewall) or any other appliance or service used to mitigate DDoS attacks against protected services, or a particular feature within a DDoS mitigation product or service. A security layer (ring) may have one or more DDoS security components. The above security components may also be known as production components. Other production components in the overall architecture may also be useful to determine DDoS security vulnerability especially in the event they do not function as expected. For example, with a network switch or routing algorithm such as BGP (Border Gateway protocol), in the event such production components contribute to DDoS vulnerability, understanding this would then become a part of a DDoS security component, for example diagnostic or other meta data from the system confirming all traffic towards services are being 100% routed through the scrubbing center and BGP settings are as expected.

“Production environment, environment, or IT environment or production IT environment” may include any aspect of an IT network, cloud, or other online services that relate to ensuring and serving business needs. For example, a bank's production environment may be online banking services or mobile banking services that customers use and rely upon for services consumed. Another example may be a gaming company that has online games that users can play on their website. Another example may be an insurance company having online VPN services for remote insurance agents to access internal insurance quoting systems. Production environments are what organizations rely upon for their business continuity for online services. Production environments are not staging or testing environments, they are live environments typically used by customers. Typically, in the event a production environment is down or unavailable, this will cause severe interruptions to business continuity. For example, if a trading platform production environment is down or unavailable to customers, customers will not be able to place trades, and this may cause severe financial damage to customers relying on the platform and the business hosting the platform. The use of the word “environment” may also be used to describe a logical or physical, or conceptual construct to understand the realm in which security operations are taking place. This allows users of the system to have a contextual understanding of how to interpret vulnerability data gained during vulnerability assessments and attack simulations, or other operational aspects. Environments may include DDOS security components, and production services. For example, an environment may be a particular subnet of production services, a particular region in a cloud provider, various security settings taken into consideration, or a combination thereof. Environments typically contain DDoS security components. An example of the use of the term “environment” may be, “In the London environment using vendor_x DDOS protection, an overall vulnerability level of 38%” was identified. Another example is, “Go check the Chicago environment for all layer 4DDoS attacks”. There are many uses for the term “environment”, and the meaning may depend on the context.

“DDoS attack surface” may include the cumulation of all potential points in an organization that may be attacked by a DDoS attack. Typically, to calculate the DDoS attack surface, all known external facing (e.g., Internet-facing) IPs (Internet Protocols), FQDNs, and services are multiplied by DDoS attacks that could be used by an attacker. The services may include, for example, all cloud and datacenter services or any service that is a receptor for an attacker to attack. Online services or targets that could be attacked by a DDoS attack may also be a part of the DDoS attack surface. In high-security environments, the same concept may be used, but online services are only available to other internal environments. For example, a single point on a DDOS attack surface for an organization could be: (8.8.8.8 (IP address)+443 (Service/Port)+ACK Flood (DDoS attack vector)), which represents a single possible attack point for the attack surface for that environment.

“DDoS threat scoring” may include a score that represents the vulnerability level of a service/component/environment for a DDoS attack. In other words, the score is an indicator of the chances of a DDoS attack affecting the service/component/environment. An example for an environment may be a “Medium threat rating for the banking industry”. Another example may be, “78% chance of a DDoS attack succeeding if attacked”. More complex, simple, granular, subject-specific, industry-specific, or any other suitable uses may be used.

“DDoS attack vector” (also referred to as, “attack vector”) may include a method or technique used to conduct a DDoS attack. The attack vector may also include specific DDOS attack types and service combinations or just DDOS attack type by itself, for example, “HULK+port 443”, or “ICMP Flood”, “SYN Flood”, “Broken attack rhythm”, “sporadic attack rhythm”. The attack vector may also include the path taken by attack traffic to reach its target. Understanding the attack vector or the nature of it is essential for effective defense against DDoS attacks. This is because DDoS mitigation systems and/or services are unable to identify and/or effectively mitigate such attacks. In the event a DDoS mitigation system is not configured effectively to mitigate specific attack vectors or methods, this will mean when an organization is actually attacked by a threat actor, the organization will likely suffer damaging impact, i.e., the DDoS attack was not mitigated, and was able to damage business continuity for such organizations online services. “DDoS Vulnerability Data” may include data that indicates where a vulnerability is in the deployed protection or services protecting an Information Technology (IT) production environment against DDoS attacks. For example, DDoS vulnerability data may result from, if an attack is launched toward a target in the protected IT environment, and the DDoS attack would disrupt, damage, or take down such a target or other services in such an environment. Such data may also include knowledge of protected status vulnerabilities, e.g., an understanding that when attacked, that a particular target and service will not be affected. An example of a DDoS vulnerability is: (8.8.8.8 (IP address)+443 (Port)+ACK Flood (DDoS attack vector))=Vulnerable.

The above DDoS vulnerability example was based on 90% of attack traffic leaking through, for example, in accordance with testing performed in accordance with the systems described in U.S. Pat. No. 10,509,909 and PCT Publication WO 2023/057950, when launching the above combination against the protected environment, and represents a single vulnerability of the DDoS attack surface being scrutinized.

“Production originating DDoS vulnerability data” may include DDoS vulnerability data that has been gathered from production environment(s), e.g., live environment/s with online services, used by users. This is not an environment in a laboratory or staging environment. Production originating DDoS vulnerability data may also come from other sources, such as successful or unsuccessful DDoS attack events from mitigation systems (or components), or any type of disruptive DDoS testing.

“Successful/Unsuccessful DDoS attack event” may include an event where either an attack was successful in taking down or adversely affecting Information Technology (IT) production environment services (production network), targets or networks, or where an attack was unable to take down or adversely affect the production environment services, targets or networks.

“A statistical model” may include a mathematical model that embodies a set of statistical assumptions concerning the generation of sample data. It may be specified as a mathematical relationship between one or more random variables and other non-random variables. The statistical model may include a regression (e.g., linear regression) and/or a classification (e.g., logistic regression). One common trait of statistical models is that they are based on probability theory and statistical inference. This means that they use mathematical functions to represent the probability distribution of the data, which can be used to estimate the parameters of the population from which the data was sampled. These assumptions may include things like linearity, normality, independence, and homoscedasticity.

“Supervised learning model” may include usage of algorithms which use known information-data and results from historical and/or ongoing tests. The algorithms learn the patterns in the data which are correlated with results. Supervised learning models, include, for example, neural network models, linear regression, and logistic regression models.

“Supervised learning” may utilize a machine learning paradigm for problems where the available data consists of labelled examples, meaning that each data point contains features (covariates) and an associated label. The goal of supervised learning algorithms is learning a function that maps feature vectors (inputs) to labels (output), based on example input-output pairs. Supervised learning infers a function from labeled training data including a set of training examples. In supervised learning, each example is a pair consisting of an input object (typically a vector) and a desired output value (also called the supervisory signal). A supervised learning algorithm analyzes the training data and produces an inferred function (a function that is deduced or determined automatically based on available data or information), without explicitly defining it. The inferred function may be derived from observed patterns and relationships in data, and is used to make predictions based on input data without explicitly specifying the functional form of the relationship, which may be used for mapping new examples. An optimal scenario may allow the algorithm to correctly determine the class labels for unseen instances. This may require the learning algorithm to generalize from the training data to unseen situations in a “reasonable” way. This statistical quality of an algorithm is measured through a so-called generalization error.

“Unsupervised learning model” may include usage of algorithms which use known information-data without the results from historical and/or ongoing tests. The algorithms learn patterns based on similarities within the data samples, and are used to discover new insights and correlations between data. Unsupervised learning models suitable for use the disclosed embodiments/examples, include, for example, neural network models, k-means, PCA (Principal component analysis), and other unsupervised models.

“Unsupervised learning” may utilize models that learn patterns through mimicry from untagged data. Unsupervised methods exhibit self-organization, such that the models capture patterns as probability densities, or a combination of neural feature preferences encoded in the machine's weights and activations.

“Reinforcement learning models” may replicate procedures and operations, which intelligent agents use to take actions in an environment to maximize the notion of cumulative reward. These models are used to optimize the vulnerability score of an environment by researching different parameters (e.g., attack vector flows, attack vector combinations, thresholds, timing of an attack).

“Variations of Machine Learning and Artificial Intelligence” may include, but are not limited to, weak learning, semi supervised, self-supervised, dynamic learning, active learning, experiential learning, contrastive learning, genetic algorithms, and/or bio-inspired algorithms. This disclosure does not discuss every possible machine learning technique. However, any suitable machine learning technique may be applied to disclosed embodiments.

Examples of machine learning and artificial intelligence models for implementation with disclosed embodiments may include any one or more of the following models.
(1) Deep Neural Networks (Deep Learning). A deep neural network (DNN) is an artificial neural network (ANN) with multiple layers between the input and output layers. There are diverse types of neural networks, but they generally include the same components: neurons, synapses, weights, biases, and functions. DNNs are part of a broader family of machine learning methods based on artificial neural networks with representation learning. Learning can be supervised, unsupervised, or reinforcement, as detailed above herein.
(2) K nearest neighbors (k-NN). This is a form of non-parametric supervised learning. It is used for classification and regression. In both cases, the input typically includes the k closest training examples in a data set. The output depends on whether k-NN is used for classification or regression.
(3) Support vector machines (SVM). These are supervised learning models with associated learning algorithms that analyze data for classification and regression analysis. Given a set of training examples, each marked as belonging to one of two categories, an SVM training algorithm builds a model that assigns new examples to one category or the other.
(4) Logistic regression. This is a statistical model that models the probability of an event taking place by having the log-odds for the event be a linear combination of one or more independent variables. In regression analysis, logistic regression includes estimating the parameters of a logistic model (the coefficients in the linear combination). Formally, in binary logistic regression there is a single binary dependent variable, coded by an indicator variable, where the two values are labeled “0” and “1”, while the independent variables can each be a binary variable (two classes, coded by an indicator variable) or a continuous variable.
(5) Linear regression. This is a linear approach for modeling the relationship between a scalar response and one or more explanatory variables. The relationships are modeled using linear predictor functions whose unknown model parameters are estimated from the data.
(6) Random forest. This is an ensemble learning method for classification, regression and other tasks and operates by constructing a multitude of decision trees at the time of training. For classification tasks, the output of the random forest is the class selected by most trees. For regression tasks, the mean or average prediction of the individual trees is returned.
(7) K-Means clustering. This is a method of vector quantization, which aims to partition n observations into k clusters in which each observation belongs to the cluster with the nearest mean (cluster centers or cluster centroid), serving as a prototype of the cluster. This results in a partitioning of the data space into Voronoi cells. k-means clustering minimizes within-cluster variances (squared Euclidean distances).

### System Description

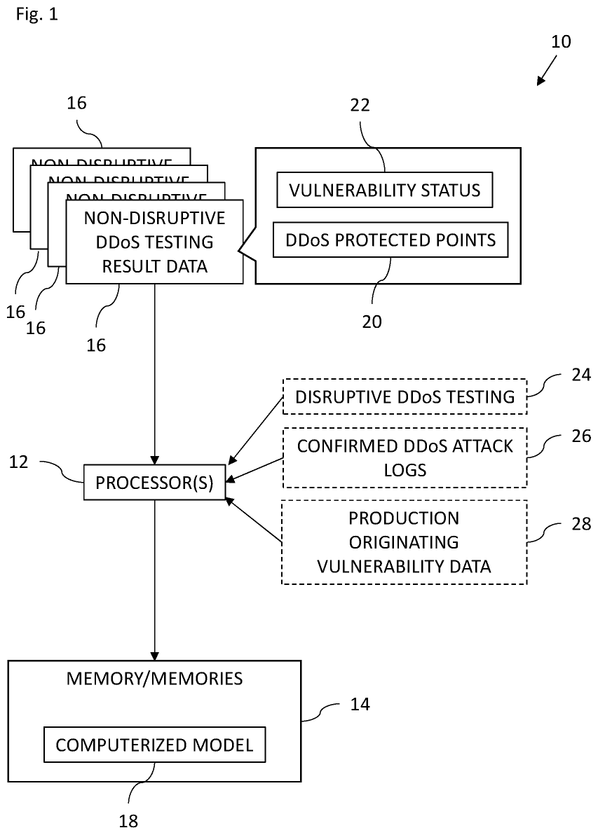

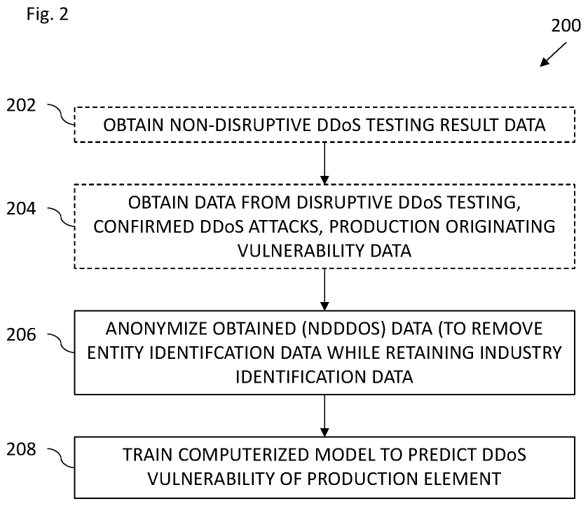

Reference is now made to FIGS. 1 and 2. FIG. 1 is a block diagram view of a DDOS vulnerability prediction model training system 10 constructed and operative in accordance with an embodiment of the present disclosure. FIG. 2 is a flowchart 200 including steps in a method of operation of the DDOS vulnerability prediction model training system 10 of FIG. 1. The DDOS vulnerability prediction model training system 10 includes one or more processors 12, and one or more memories 14. The memory/memories 14 is/are configured to store data used by the processor(s) 12.

The processor(s) 12 is configured to obtain Non-Disruptive DDoS (NDDDOS) testing result data 16 (block 202). The Non-Disruptive DDoS (NDDDOS) testing result data 16 may be testing data acquired from testing multiple different production environments. The NDDDOS testing result data 16 may include DDoS-protected points 20 and/or any one or more of: a vulnerability status 22; a protected status; or a varying degree of vulnerability (of different services/targets in different production environments to different attack vectors), as well as DDOS security protection provided in each of the different production environments. In other embodiments, the processor(s) 12 is configured to obtain data from sources including one or more of the following: Non-Disruptive DDoS testing 16; disruptive DDoS testing 24; confirmed DDoS attack logs 26; or production originating vulnerability data 28 (block 204). The obtained data is described in more detail in disclosed embodiments.

In some embodiments, the processor(s) 12, for example, is configured to anonymize the NDDDOS testing result data 16 (block 206) and/or the data obtained in the step of block 204. In some embodiments, the processor(s) 12, for example is configured to anonymize the NDDDOS testing result data 16 to remove entity identification data (e.g., company or organization name data) while retaining industry identification data (e.g., industry type such as banking, insurance, manufacturing, retail).

The processor(s) 12 is configured to train a computerized model 18 with the (anonymized) Non-Disruptive DDoS testing result data 16, and/or with the (anonymized) data obtained in the step of block 204, to predict DDoS vulnerability of a production element (block 208). The production element may include any one or more of the following: a production target; a production service; a production component; or a production environment.

In some embodiments, the processor(s) 12 is configured to train the computerized model 18 with the NDDDOS testing result data 16 to predict a DDoS vulnerability level of the production element. In some embodiments, the processor(s) 12 is configured to train the computerized model 18 with the NDDDOS testing result data 16 to predict DDoS vulnerability of the production element based on environmental data of the production element, as described in more detail in disclosed embodiments. The environmental data of the production element may include data about one or more DDOS protection layers used to protect the production element. The environmental data is described in more detail in disclosed embodiments.

In some embodiments, the processor(s) 12 is configured to train the computerized model using any one or more of the following: machine learning; artificial intelligence; supervised learning; unsupervised learning; reinforcement learning.

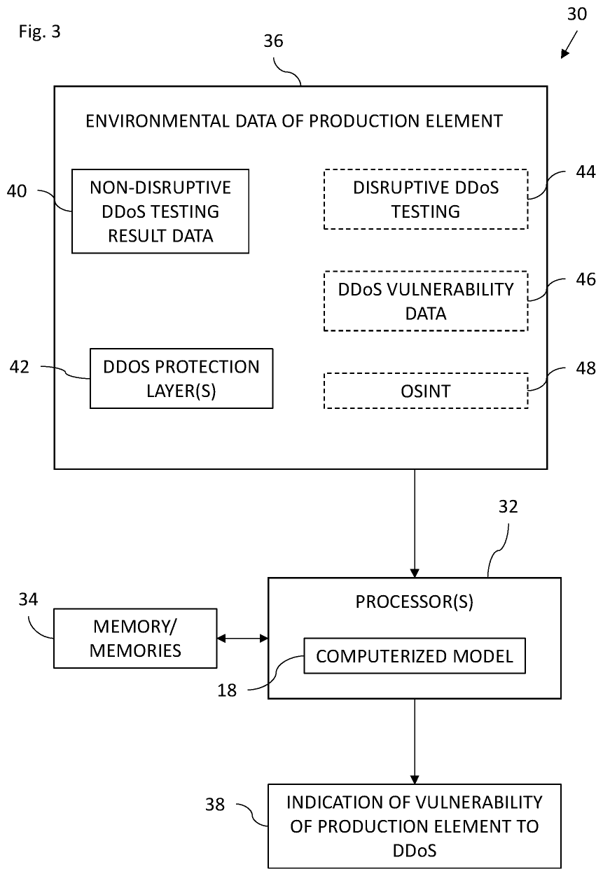

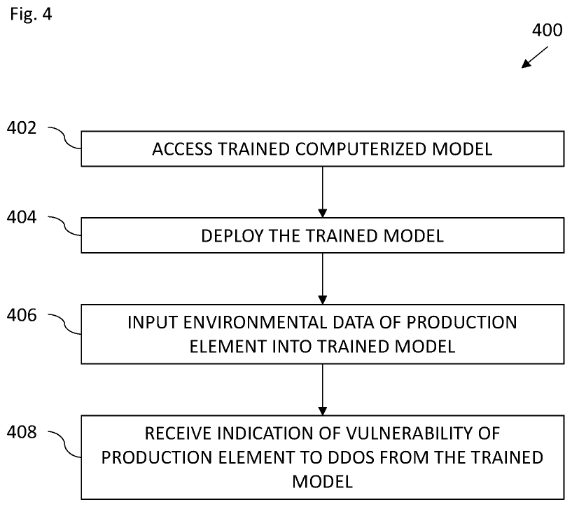

Reference is now made to FIGS. 3 and 4. FIG. 3 is a block diagram view of a DDOS vulnerability prediction system 30 constructed and operative in accordance with an embodiment of the present disclosure. FIG. 4 is a flowchart 400 including steps in a method of operation of the DDOS vulnerability prediction system 30 of FIG. 3. The DDOS vulnerability prediction system 30 includes one or more processors 32, and one or more memories 34. The memory/memories 34 is/are configured to store data used by the processor(s) 32.

The processor(s) 32 is configured to access the computerized model 18, trained to predict DDoS vulnerability of a production element (block 402). The term “access” may include finding and/or retrieving the computerized model 18 from the memory/memories 14. The production element may include any one or more of the following: a production target; a production service; a production component; or a production environment. As previously mentioned with reference to FIG. 1, the computerized model 18 may be trained with Non-Disruptive DDoS testing result data 16 (and/or data from any one or more of the following data sources: disruptive DDoS testing 24; confirmed DDoS attack logs 26; or production originating vulnerability data 28) to predict DDoS vulnerability of the production element. The NDDDOS testing result data 16 used to train computerized model 18 may include DDoS-protected points 20 (FIG. 1) and vulnerability statuses of different services/targets in different production environments to different attack vectors as well as the DDOS security protection provided in each of the different production environments.

The processor(s) 32 is configured to deploy the trained computerized model 18 (block 404). The term “deploy” may include using the computerized model 18 as described in more detail with reference to steps of blocks 406-408. The processor(s) 32 is configured to input environmental data 36 of the production element into the trained computerized model 18 (block 406). The environmental data 36 may include a given set of data from Non-Disruptive DDoS (NDDDOS) testing results 40. The NDDDOS testing results 40 comprise parameters including any one or more of the following: a response time; a leakage rate and volume on service; a leakage rate and volume on environment; or a number and rate of blocked requests. The data of the Non-Disruptive DDoS (NDDDOS) testing results 40 is described in more detail with reference to disclosed embodiments. The environmental data 36 may include data about at least one DDOS protection layer 42 used to protect the production element. The environmental data 36 of the production element may be derived from any one or more of the following: Non-Disruptive DDoS (NDDDOS) testing 40; disruptive DDoS testing 44; DDoS vulnerability data 46; and/or Open-Source Intelligence (OSINT) 48.

The processor(s) 32 is configured to receive an indication 38 of vulnerability of the production element to DDoS from the trained computerized model 18 (block 408) based on processing the input environmental data 36. The indication 38 of vulnerability may include any one or more of the following: a vulnerability status; a protected status; or a varying degree of vulnerability (e.g., a percentage or score indicating vulnerability of the production element to one or more attack vectors).

Disclosed embodiments provide examples of training and using the computerized model 18 as well as various examples of inputs and outputs of the computerized model 18.

Below is a general description of example “inputs” and “outputs” for the computerized model(s) 18, or other models in the disclosed embodiments. The following “main inputs” may be used in any one or more of the examples detailed below: service type, CDN vendor if it exists, scrubbing center if it exists, CPE (Customer Premise Equipment) if it exists, WAF (Web Application Firewall) if it exists, Direct/CDN access if it exists, FQDN/IP type, subnet size, response time, open ports on target, IP listing of service, single/multi nodes of service, attack type, vulnerability status (e.g., leakage in service and in the environment), number of blocked requests. ND-DDoS (Non-Disruptive DDoS testing) test results may be part of “main inputs”. “Main inputs” may include parameters such as: response time, leakage rate and/or volume on service, leakage rate and/or volume of traffic generated towards the environment, number and rate of blocked requests, number and rate of leaked requests and detailed results information on all services in the environment. The abovementioned parameters are, for example, generated by the systems disclosed in U.S. Pat. No. 10,509,909 and PCT Publication WO 2023/057950.

The following examples may be an “additional input”, for the computerized models 18 including: (i) log entry: “Attack towards target X=damaged”, i.e., a log entry from any DDoS mitigation platform where the target was confirmed to be damaged by a DDoS attack; and/or (ii) log entry: “Attack towards target X=protected”, i.e., a log entry from any DDoS mitigation platform where the target was confirmed to be protected by a targeted DDoS attack. Other data gathering from production environments where a confirmed DDoS attack has been deemed vulnerable or protected, may or may not be utilized as additional input.

Both input and output parameters and/or variables are subject to change over time with the changing nature of the art, or the system model being applied. Efficiency is decided on the practicality of the purposes required.

The following examples are for either supervised, unsupervised, or reinforcement learning.

EXAMPLE 1 describes a reinforcement learning model with a system scheduler to control attack simulations. The implementation of a system scheduler in attack simulations can dictate the scheduling of the attack simulations, impacting the order in which they are sent and the efficiency of coverage in identifying potentially damaging DDoS attack vectors in the production environment being evaluated. The resultant scheduling is based on the output of the reinforcement learning model and may vary depending on the case. With this implementation, it is possible to control various aspects of the attack, such as the rhythm (e.g., pattern or characteristics of the attack) and volume of specific attack vector executions, as well as whether the attack should change the current attack vector. The simulation agent in the reinforcement model has several actions it may take based on the state of the simulation environment. After selecting an action (by the simulation agent), the simulator replicates the effect of that action on the simulation environment, updates the model based on the reward, and calculates the updated extracted features. This cycle is repeated until the maximum training capability is reached.

For this example, a label is not required for the reinforcement learning model. However, the optimization is based on parameters such as average monitoring response time, average monitoring leakage of service, and average monitoring of packet or connection leakage. Some examples of leakage include TCP/IP, DNS, ICMP, UDP and HTTP packet leakage, all of which can lead to network outages, network disruptions, or other security threats of the environment, and the number of blocked requests, as defined in systems, such as those disclosed in U.S. Pat. No. 10,509,909 and PCT Application Publication WO 2023/057950.

All “main inputs” and/or “additional inputs” may be used in this example. One or more “output” recommendations may be a sorted list of attack vector identifiers (e.g., SYN Flood, HTTP Flood, and the like) that will benefit the evaluation process and most likely run sequentially through such an output list, or else use such a list for Non-Disruptive DDoS testing to get to the most vulnerable checks first or at some specific point of a sequence, or any other product application where determining of the most vulnerable areas of the environment are useful.

EXAMPLE 2 describes a supervised learning model to predict DDoS vulnerabilities for a production target. This example provides one of the ways a supervised learning model can predict the DDoS vulnerability status of a specific target using Non-Disruptive testing data. This result would typically be “vulnerable” or “protected” at the end of flow if used for human consumption. Else the result may remain numeric, e.g., if consumed by some other process. The label in the model for this example is a numerical value between 0.0 and 1.0, which reflects the leakage of attack simulation towards the target. Inputs may include all “main inputs” and/or “additional inputs”. The output recommendation can be, for example, a numeric score (e.g., between 0.0 and 1.0) which reflects the vulnerability assessment of a specific target. This status will either be used internally by the overall system or output as a human-readable conclusion, e.g., “Vulnerable” or “Protected”.

EXAMPLE 3 describes a supervised learning model to predict DDoS vulnerabilities for an organization (enterprise). This example shows one of the ways in which a supervised learning model can predict the DDoS vulnerability status of a specific target organization, entity, company, enterprise, or environment using Non-Disruptive testing data. The result would typically be “vulnerable” or “protected” at the end of flow if used for human consumption, else the result may remain numeric, e.g., if consumed by some other process.

The label in the model for this example is a numerical value between 0.0 to 1.0. An aggregative score of all components in the organization, entity, company, enterprise, or environment, which reflects the relative vulnerability level of the leakage in that organization, entity, company, enterprise, or environment may be provided. Inputs may include all “main inputs” and/or “additional inputs”. The output recommendation can be a decimal score (e.g., between 0.0 and 1.0) which reflects the vulnerability assessment of a specific target organization, entity, company, enterprise, or environment, derived from the level of relative leakage of attack traffic into the organization, entity, company, enterprise, or environment based on Non-Disruptive testing data. This status will either be used internally by the overall system or output as a human-readable conclusion e.g., “Vulnerable” or “Protected”.

EXAMPLE 4 is a supervised learning model to predict DDoS vulnerability for a specific security layer. This example shows one of the ways in which a supervised learning model can predict the DDoS vulnerability status of a specific or general defensive security layer (also be referred to as “security ring”) component, such as, for example, a scrubbing center, Firewall, CPE, and the like. Some layers may combine one or more defense components to make up such a security layer. A view of the layer or specific components within the layer will be extrapolated from such an example.

The label in the model for this Example is decimal values between 0.0 and 1.0, one for each security ring, reflecting the vulnerability level of each security ring and or its specific defense components. Inputs may include all “main inputs” and/or “additional inputs”. The output recommendation for this example is decimal values between 0.0 to 1.0, one for each security ring, reflecting the vulnerability level of each security ring and or its specific defense components. e.g., Scrubbing Center=vulnerable.

EXAMPLE 5 describes a supervised learning model to predict vulnerability to multi-vector DDoS attacks. This example shows one of the ways in which a supervised learning model can predict the chance of simultaneous multi-vector DDoS attacks penetrating a vulnerability in the defended organization, company, or environment. Inputs may include all “main inputs”, or combinations of attack vectors, or “additional inputs”. An example of an output recommendation can be tuples or triplets or more, of attack vectors, that have the most chance of succeeding, if they are executed simultaneously. Each combination is assigned a “success score”, for example: SYN attack+ACK attack=0.7. This can also further be post-processed to a human-readable “vulnerable” or “protected” status.

EXAMPLE 6 describes a reinforcement learning model to predict attack mitigation thresholds. In this reinforcement learning model, attack thresholds which can penetrate or be protected against are deciphered, for a particular organization, entity, company, enterprise, or environment DDoS defenses. The model of this example, while used with reinforcement learning, may also be used with models, such as supervised learning models (e.g., neural network models, linear regression models, logistic regression models), and unsupervised learning models (e.g., neural network models, k-means models, PCA models). Inputs may include all “main inputs” and/or “additional inputs”. The example outputs the thresholds for an attack and/or attacks that enable the successful penetration or protection of the specific environment. For example, an ACK Flood at 1 Gbps is protected, or an ACK Flood at 1 Gbps is vulnerable. Another potential example of usage of such information may be “SYN Flood->Run 10 Mbps faster->To check protection threshold”.

EXAMPLE 7 is an unsupervised learning model. This example provides an unsupervised learning model for the task of “service vulnerability assessment”. This model discovers unknown scenarios in a task called “vulnerability assessment”. The algorithm used is known as “Isolation Forest” (for example, as disclosed in F. T. Liu, et al., “Isolation Forrest”, 2008 Eighth IEEE International Conference on Data Mining, Pisa, Italy, 2008 pp. 413-422), which is a mathematical function. “Isolation Forrest” is effective for the task of anomaly detection. Isolation Forest learns the patterns of the data without additional human labels, then, the algorithm can detect abnormal input and mark it as an anomaly. Isolation Forest detects anomalies based on the fact that anomalies are data points that are few and different. The prediction is made for a sequence of values.

Inputs may include three parameters which are time series data that is synchronized: (i) response time, over time (e.g., 51,53,49,43,47,56,51,77,54); (ii) sent traffic, over time (e.g., 150,165,130,140,145,150); (iii) received traffic, over time (e.g., 145,159,71,134,141,14). The output of the model is a decimal score that reflects how “normal” or “abnormal” that sequence is, or in other words, if the service is vulnerable or not.

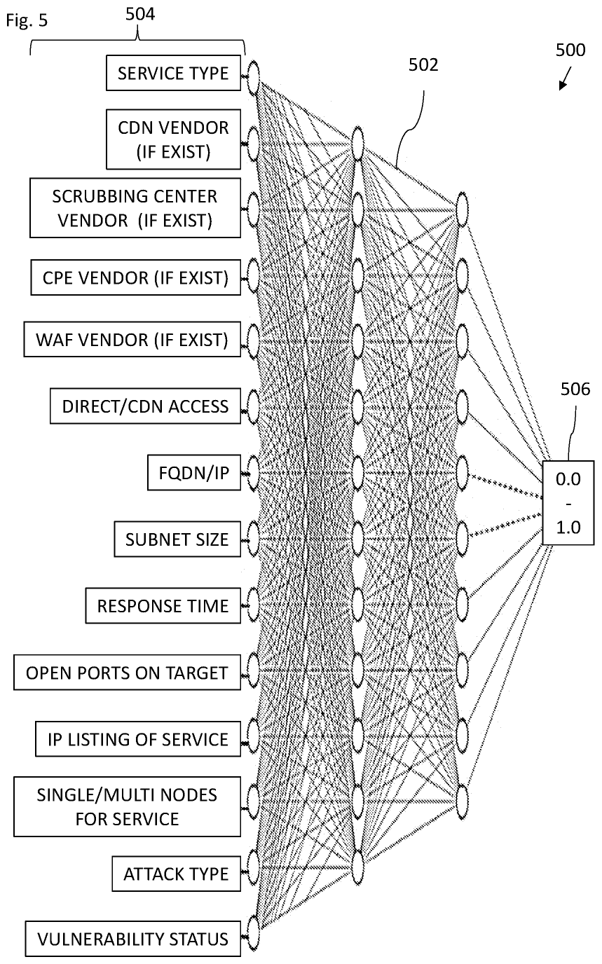

Reference is now made to FIG. 5, which is a schematic view of an example classification model 500 implemented with a deep neural network 502 for use in systems 10, 30 of FIGS. 1 and 3. The deep neural network 502 is an example of a neural network used to create a prediction model for “company/environment/service vulnerability assessment”. FIG. 5 shows example inputs 504 such as service type, CDN vendor if existing, scrubbing center if existing, CPE if existing, WAF if existing, Direct/CDN access if existing, FQDN/IP type, subnet size, response time, open ports on target, IP listing of service, single/multi nodes of service, attack type, vulnerability status. Deep neural network 502 is an example of a model. The classification model 500 may use different variations of deep neural networks and other kinds of statistical models as well. The example output 506 of classification model 500 is a score between 0.0 to 1.0 which is post-processed and normalized according to the variance and distribution of the model output on all the training datasets. The meaning of the score is a representation of how vulnerable a service/component/environment is to a DDoS attack. Expressed in other words, the score reflects the probability (chances) of the DDoS attack affecting the service/component/environment.

The training of the model 500 is based on data from nondisruptive DDoS testing, for example, such as: service type, CDN vendor if existing, scrubbing center if existing, CPE if existing, WAF if existing, Direct/CDN access if existing, FQDN/IP type, subnet size, response time, open ports on target, IPs of service, single/multi nodes of service, attack type, vulnerability status. The training data may be divided into three datasets to train the model and validate it during training, validation, and testing, respectively. The training may be divided into several resolutions, for example: company/environment/service and more.

For each training session of the model 500, results of NDDDOS testing as annotations are obtained and used, for example, from the systems disclosed in U.S. Pat. No. 10,509,909 and PCT Application Publication WO 2023/057950. NDDDOS test results may include parameters such as: response time, leakage rate and volume on service, leakage rate and volume on environment, number, and rate of blocked requests, and detailed result information on all services in the environment. The parameters may be aggregated into a single numeric value which is used as “labels” in training.

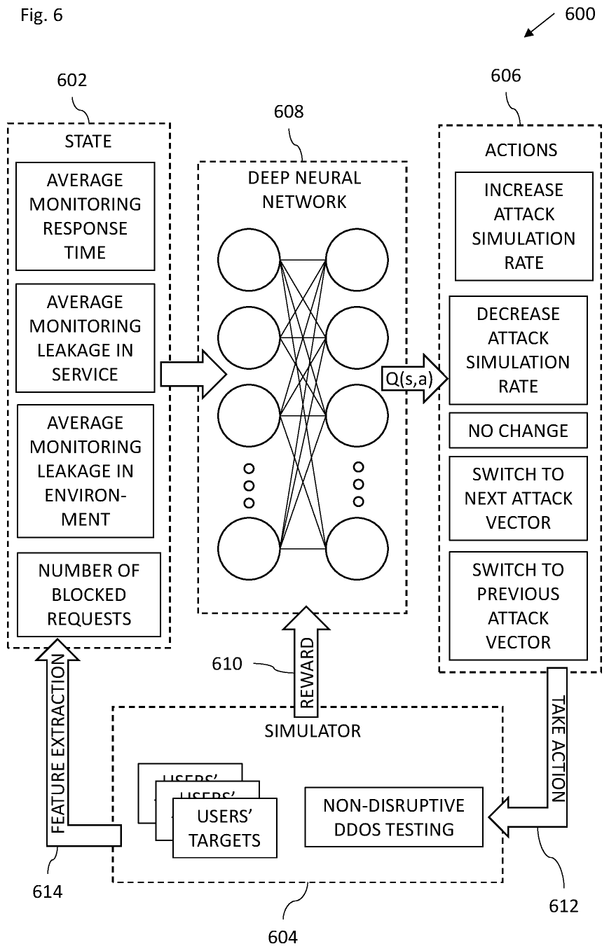

Reference is now made to FIG. 6, which is a schematic view of an example of a deep reinforcement learning model 600 for Non-Disruptive testing system schedulers for use in systems 10, 30 of FIGS. 1 and 3. The deep reinforcement learning model 600 is an example of a reinforcement learning model used for a task such as scheduling tests, i.e., the tests which should be performed, and the order in which the individual tests should be performed, and the specific times for testing to be implemented. The deep reinforcement learning model 600 may control the way that an attack occurs, it may control the rhythm and volume of a specific attack vector execution and determine if the attack should change the current attack vector. The deep reinforcement learning model 600 includes a deep neural network 608.

In accordance with a state 602 of the environment, a simulator 604 (or agent) has several actions 606, which it can perform. After choosing one or more actions (examples are listed in FIG. 6), the simulator 604 mimics the effect of the chosen action(s) on the environment (arrow 612), updates the deep neural network 608 according to a reward 610, and calculates updated extracted features (arrow 614) that update the state 602. This cycle repeats until a maximum training capability has been reached. Examples of the state are shown in FIG. 6.

Example actions 606 that the agent 604 may take and that may have an effect on the response and behavior of the environment include, for example, increase rate of the current attack, decrease rate of the current attack, no change in the rate of the current attack, switch to the next attack vector and start the attack with it, and switch to the previous attack vector and start the attack with it.

Example extracted features 614 that give an indication of the environment state, and how protected or vulnerable it is, for example, one or more of: average response time for sent requests, average packets leakage in service, average packets leakage in the environment, number of blocked requests. To perform the operation and tests, the system environment is such that it mimics real-life environments. Example data used by the simulator 604 is shown in the broken line box 604.

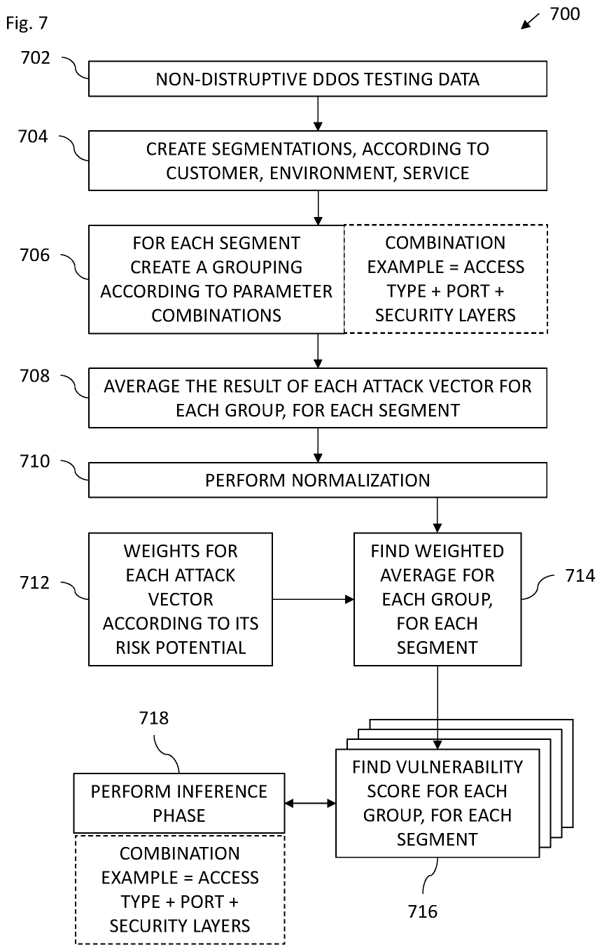

Reference is now made to FIG. 7, which is schematic view of an example statistical model for vulnerability assessment 700 for use in systems 10, 30 of FIGS. 1 and 3. The statistical model 700 may be for company and/or environment and/or service vulnerability assessment. The statistical model for vulnerability assessment 700 is an example of a statistical model and is a pipeline for inference in a task “vulnerability assessment”. Based on gathered data of NDDDOS testing, e.g., from the RADAR product (available from Mazebolt Technologies Ltd. of Israel), segmentation of the data may be created including: (i) customer; (ii) environment; and (iii) service (block 704).

Input to the statistical model for vulnerability assessment 700 is from, for example, ND-DDoS test results 702, and may include parameters such as: response time, leakage rate and volume on service, leakage rate and volume on environment, number and rate of blocked requests, detailed results information on all services in environment. The parameters may be aggregated to a single numeric value, which is used as “labels” in the training. For each segment, the results of the attack vectors tests are grouped according to a parameter combination, with parameter combinations including, for example, access type, port, security layers (block 706). The average vulnerability result of each attack vector for each grouping for each segment is then calculated (block 708). The results are normalized to create more accurate and distributed vulnerability scores (block 710).

Using additional data known about the potential risk of each attack vector, such as weights for each attack vector according to its risk potential (block 712), a weighted average vulnerability scoring of the normalized scores for each group and each segment is found (block 714). Normalized vulnerability scores may be computed several times, each time for a selected segment (blocks 716). A segment is a filtered dataset according to common factors (one factor or more), to give the most accurate prediction for that segment. The normalized scores may be used for inference for services with similar parameters (block 718).

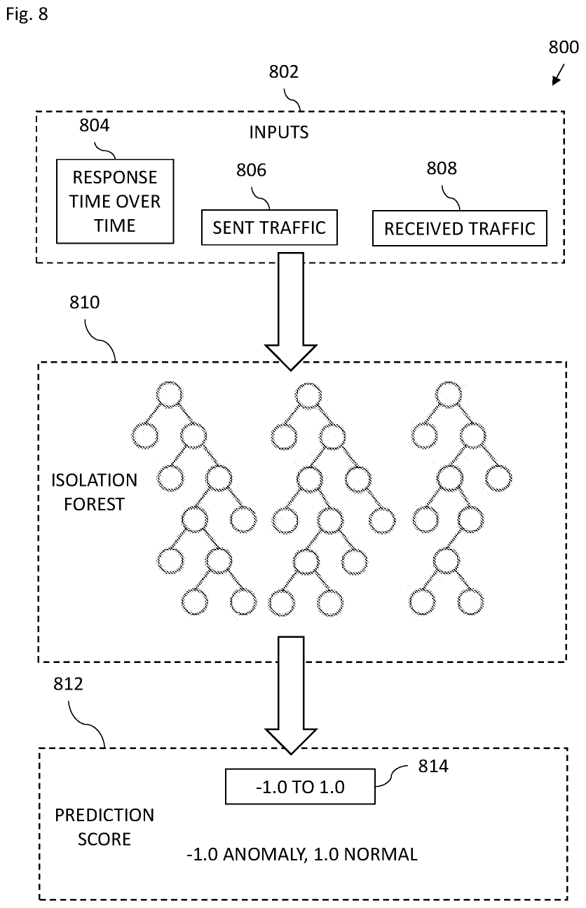

Reference is now made to FIG. 8, which is a schematic view of an example unsupervised model 800 for performing a service vulnerability assessment task in systems 10, 30 of FIGS. 1 and 3. Unsupervised model 800 is an example of an unsupervised model to discover unknown scenarios in a “vulnerability assessment” task. Inputs 802 to the unsupervised model 800 may include three parameters which are time series data that is synchronized:
(1) response time over time 804 (e.g., 51,53,49,43,47,56,51,77,54);
(2) sent traffic 806 (e.g., 150,165,130,140,145,150); and
(3) received traffic 808 (e.g., 145,159,71,134,141,14).

An “Isolation Forest” algorithm 810 is used for example, as an unsupervised machine learning technique for anomaly detection. Unlike supervised techniques, which require labeled data, Isolation Forest learns the patterns in the data without any additional human input or labels. The “Isolation Forest” algorithm 810 works by recursively partitioning the data into smaller and smaller subsets until isolated points are left as anomalies. Isolation Forest partitions the data based on the principle that anomalies are data points that are rare and different from most of the data. To achieve this, the algorithm randomly selects a feature and then randomly selects a split value within the range of that feature. The data is then partitioned based on this split value, with the aim of isolating anomalies in their own partitions. By using this approach, the Isolation Forest algorithm 810 can detect and mark abnormal data points without requiring any human intervention. This makes it a highly efficient technique for detecting anomalies in datasets.

The output of the “Isolation Forest” algorithm 810 provides a prediction score 812, and may be a decimal range (e.g., between −1.0 to 1.0) (block 814) which reflects the vulnerability assessment of a specific target. The “Isolation Forest” algorithm 810 may either be used internally by the overall system or output as a human-readable conclusion, e.g., “Vulnerable” or “Protected” or some other defined status.

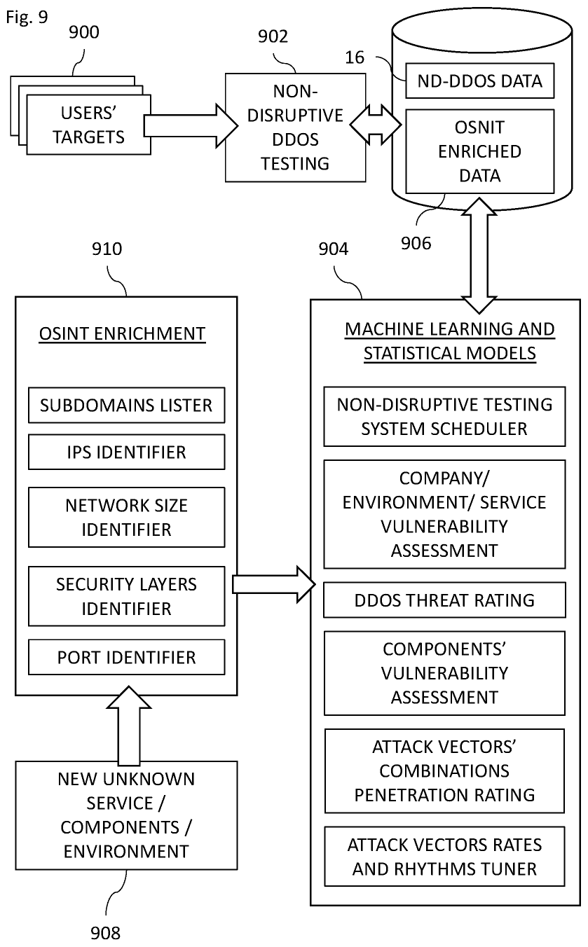

Reference is now made to FIG. 9, which is a block diagram view of an example mode of operation of the systems 10, 30 of FIGS. 1 and 3. As shown in FIG. 9, there are two input flows. The first flow starts with users' targets 900 which may utilize the system and method of U.S. Pat. No. 10,509,909 and PCT Publication WO 2023/057950 to perform Non-Disruptive DDoS testing 902 to yield Non-Disruptive DDoS (NDDDOS) testing result data 16 or any other suitable method. For a given one of the targets 900, the ND-DDoS (Non-Disruptive DDoS) testing 902 yields collected data 16 including, for example, vulnerability data, sent data, received data, response data, or any other data from the testing of the target. A target may be a service and/or a defensive component and/or an environment. ND-DDoS testing data 16 and OSINT enriched data 906 may then be used to train ML and statistical models 904. The ML and statistical models 904 may use OSINT capabilities which enrich the data. FIG. 9 lists example ML and statistical models 904 shown in the box labeled with reference numeral 904.

The second flow is from (or about) a new, unknown target 908 (unknown in terms of its DDoS vulnerabilities) and provides a set of data which is analyzed with one or more of the trained models 904. Data about the unknown target 908 may be found and/or enriched using OSINT capabilities (block 910). OSNIT examples are listed in the box labeled with reference numeral 910. The enrichment process may be performed for example, using external services like Shodan (https://www.shodan.io/), findcdn (github.com/cisagov/findcdn). An additional OSINT enrichment technique may include: checking the public CIDR ranges addresses which vendors use (and can be found in vendor documentation); and comparing obtained IP addresses with the public CIDR ranges addresses which the vendors use. The ML and statistical models 904 may then be applied to the unknown target 908 with its' enriched data (and other provided data) to provide or predict results.

The implementation of the method and/or system of examples of the disclosure can involve performing or completing selected tasks manually, automatically, or a combination thereof. Moreover, according to actual instrumentation and equipment of examples of the method and/or system of the disclosure, several selected tasks could be implemented by hardware, by software or by firmware or by a combination thereof using an operating system or a cloud-based platform.

For example, hardware for performing selected tasks according to examples of the disclosure could be implemented as a chip or a circuit. As software, selected tasks according to examples of the disclosure could be implemented as a plurality of software instructions being executed by a computer using any suitable operating system. In an exemplary example of the disclosure, one or more tasks according to exemplary examples of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed examples of the present disclosure. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various examples of computer-implemented methods are provided herein, some of which can be performed by various examples of apparatuses and systems described herein and some of which can be performed according to instructions stored in non-transitory computer-readable storage media described herein. Still, some examples of computer-implemented methods provided herein can be performed by other apparatuses or systems and can be performed according to instructions stored in computer-readable storage media other than that described herein, as will become apparent to those having skill in the art with reference to the examples described herein. Any reference to systems and computer-readable storage media with respect to the following computer-implemented methods is provided for explanatory purposes, and is not intended to limit any of such systems and any of such non-transitory computer-readable storage media with regard to examples of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration and are not intended to be exhaustive or limited to the examples disclosed. Many modifications and variations will be apparent to those of ordinary skill in the art without departing from the scope and spirit of the described examples.

As used herein, the singular form “a”, “an” and “the” include plural references unless the context clearly dictates otherwise.

It is appreciated that certain features of the disclosure, which are, for clarity, described in the context of separate examples, may also be provided in combination in a single example. Conversely, various features of the disclosure, which are, for brevity, described in the context of a single example, may also be provided separately or in any suitable sub-combination or as suitable in any other described example of the disclosure. Certain features described in the context of various examples are not to be considered essential features of those examples unless the example is inoperative without those elements.

The above-described processes including portions thereof can be performed by software, hardware and combinations thereof. These processes and portions thereof can be performed by computers, computer-type devices, workstations, cloud-based platforms, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these examples to practice without undue experimentation. The processes (methods) and systems have been described in a manner sufficient to enable persons of ordinary skill in the art to readily adapt other hardware and software as may be needed to reduce any of the examples to practice without undue experimentation and using conventional techniques.

Descriptions of examples of the disclosure in the present application are provided by way of example and are not intended to limit the scope of the disclosure. The described examples comprise different features, not all of which are required in all examples of the disclosure. Some examples utilize only some of the features or possible combinations of the features. Variations of examples of the disclosure that are described, and examples of the disclosure comprising different combinations of features noted in the described examples, will occur to persons of the art. The scope of the disclosure is limited only by the claims.

Example 1: A computer-implemented method, comprising: obtaining Non-Disruptive DDoS (NDDDOS) testing result data; and training a computerized model with the Non-Disruptive DDoS testing result data to predict DDoS vulnerability of a production element.

Example 2: The method according to example 1, wherein the training includes training the computerized model using any one or more of the following: machine learning; artificial intelligence; supervised learning; unsupervised learning; reinforcement learning.

Example 3: The method according to example 1 or example 2, wherein the training includes training the computerized model with the NDDDOS testing result data to predict DDoS vulnerability of the production element based on environmental data of the production element.

Example 4: The method according to example 3, wherein the environmental data of the production element includes data about at least one DDoS protection layer used to protect the production element.

Example 5: The method according to any of examples 1-4, further comprising anonymizing the NDDDOS testing result data.

Example 6: The method according to any of examples 1-4, further comprising anonymizing the NDDDOS testing result data to remove entity identification data while retaining industry identification data.

Example 7: The method according to any of examples 1-6, wherein the production element includes any one or more of the following: a production target; a production service; a production component; or a production environment.

Example 8: The method according to any of examples 1-7, wherein the obtained NDDDOS testing result data includes any one or more of: a vulnerability status; a protected status; or a varying degree of vulnerability.

Example 9: The method according to any of examples 1-8, wherein the NDDDOS testing result data includes DDoS-protected points.

Example 10: The method according to any of examples 1-9, wherein the training includes training the computerized model with the NDDDOS testing result data to predict a DDoS vulnerability level of the production element.

Example 11: A computer-implemented method, comprising: obtaining data from any one or more of the following: Non-Disruptive DDoS testing; disruptive DDoS testing; confirmed DDoS attack logs; or production originating vulnerability data; and training a computerized model with the obtained data to predict DDoS vulnerability of a production element.

Example 12: The method according to example 11, wherein the production element includes any one or more of the following: a production target; a production service; a production component; or a production environment.

Example 13: The method according to example 11 or example 12, wherein the training includes training the computerized model with the obtained data to predict a DDoS vulnerability level of the production element.

Example 14: A computer-implemented method, comprising: accessing, by at least one processor, a computerized model, trained to predict DDoS vulnerability of a production element; deploying the trained model by the at least one processor; inputting environmental data of the production element into the trained model; and receiving an indication of vulnerability of the production element to DDoS from the trained model.

Example 15: The method according to example 14, wherein the computerized model is trained with Non-Disruptive DDoS testing result data to predict DDoS vulnerability of the production element.

Example 16: The method according to example 15, wherein the NDDDOS testing result data includes DDoS-protected points.

Example 17: The method according to any of examples 14-16, wherein the environmental data includes a given set of data from Non-Disruptive DDoS (NDDDOS) testing results.

Example 18: The method according to example 17, wherein the NDDDOS testing results comprise parameters including any one or more of the following: a response time; a leakage rate and volume on service; a leakage rate and volume on environment; or a number and rate of blocked requests.

Example 19: The method according to any of examples 14-18, wherein the environmental data of the production element includes data about at least one DDoS protection layer used to protect the production element.

Example 20: The method according to any of examples 14-19, wherein the environmental data of the production element is derived from any one or more of the following: Non-Disruptive DDoS (NDDDOS) testing; disruptive DDoS testing; DDoS vulnerability data; and/or Open-Source Intelligence (OSINT).

Example 21: The method according to any of examples 14-20, wherein the production element includes any one or more of the following: a production target; a production service; a production component; or a production environment.

Example 22: The method according to any of examples 14-21, wherein the indication of vulnerability includes any one or more of the following: a vulnerability status; a protected status; or a varying degree of vulnerability.

Example 23: A system, comprising: at least one processor configured to: obtain Non-Disruptive DDoS (NDDDOS) testing result data; and train a computerized model with the Non-Disruptive DDoS testing result data to predict DDoS vulnerability of a production element; and at least one memory configured to store data used by the at least one processor.

Example 24: A system, comprising: at least one processor configured to: obtain data from any one or more of the following: Non-Disruptive DDoS testing; disruptive DDoS testing; confirmed DDoS attack logs; or production originating vulnerability data; and train a computerized model with the obtained data to predict DDoS vulnerability of a production element; and at least one memory configured to store data used by the at least one processor.

Example 25: A system, comprising: at least one processor configured to: access a computerized model trained to predict DDoS vulnerability of a production element; deploy the trained model; input environmental data of the production element into the trained model; and receive an indication of vulnerability of the production element to DDoS from the trained model; and at least one memory configured to store data used by the at least one processor.

It will thus be appreciated that the examples described above do not limit the disclosed subject matter to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

1.-25. (canceled)

26. A computer-implemented method, comprising:
obtaining Non-Disruptive DDoS (NDDDOS) testing result data; and
training a computerized model with the Non-Disruptive DDoS testing result data to predict DDoS vulnerability of a production element.

27. The method according to claim 26, wherein the training includes: 1) training the computerized model using any one or more of the following: machine learning; artificial intelligence; supervised learning; unsupervised learning;
reinforcement learning, and/or 2) training the computerized model with the NDDDOS testing result data to predict DDoS vulnerability of the production element based on environmental data of the production element.

28. The method according to claim 27, wherein the environmental data of the production element includes data about at least one DDoS protection layer used to protect the production element.

29. The method according to claim 26, further comprising anonymizing the NDDDOS testing result data.

30. The method according to claim 26, wherein the production element includes any one or more of the following: a production target; a production service; a production component; or a production environment.

31. The method according to claim 26, wherein the obtained NDDDOS testing result data includes: 1) any one or more of: a vulnerability status; a protected status; or a varying degree of vulnerability, and/or 2) DDoS-protected points.

32. The method according to claim 26, wherein the training includes training the computerized model with the NDDDOS testing result data to predict a DDoS vulnerability level of the production element.

33. A computer-implemented method, comprising:
obtaining data from any one or more of the following: Non-Disruptive DDoS testing; disruptive DDoS testing; confirmed DDoS attack logs; or production originating vulnerability data; and
training a computerized model with the obtained data to predict DDoS vulnerability of a production element.

34. The method according to claim 33, wherein the production element includes any one or more of the following: a production target; a production service; a production component; or a production environment.

35. The method according to claim 33, wherein the training includes training the computerized model with the obtained data to predict a DDoS vulnerability level of the production element.

36. A computer-implemented method, comprising:
accessing, by at least one processor, a computerized model, trained to predict DDoS vulnerability of a production element;
deploying the trained model by the at least one processor;
inputting environmental data of the production element into the trained model; and
receiving an indication of vulnerability of the production element to DDoS from the trained model.

37. The method according to claim 36, wherein the computerized model is trained with Non-Disruptive DDoS testing result data to predict DDoS vulnerability of the production element.

38. The method according to claim 37, wherein the NDDDOS testing result data includes DDoS-protected points.

39. The method according to of claim 36, wherein the environmental data includes a given set of data from Non-Disruptive DDoS (NDDDOS) testing results, and/or data about at least one DDoS protection layer used to protect the production element.

40. The method according to claim 39, wherein the NDDDOS testing results comprise parameters including any one or more of the following: a response time; a leakage rate and volume on service; a leakage rate and volume on environment; or a number and rate of blocked requests.

41. The method according to claim 36, wherein the environmental data of the production element is derived from any one or more of the following: Non-Disruptive DDoS (NDDDOS) testing; disruptive DDoS testing; DDoS vulnerability data; and/or Open-Source Intelligence (OSINT).

42. The method according to claim 36, wherein the production element includes any one or more of the following: a production target; a production service; a production component; or a production environment.

43. The method according to claim 36, wherein the indication of vulnerability includes any one or more of the following: a vulnerability status; a protected status; or a varying degree of vulnerability.

44. A system, comprising:
at least one processor configured to:
obtain data from any one or more of the following: Non-Disruptive DDoS testing; disruptive DDoS testing; confirmed DDoS attack logs; or production originating vulnerability data; and
train a computerized model with the obtained data to predict DDoS vulnerability of a production element; and
at least one memory configured to store data used by the at least one processor.

45. A system, comprising:
at least one processor configured to:
access a computerized model trained to predict DDoS vulnerability of a production element;
deploy the trained model;
input environmental data of the production element into the trained model; and
receive an indication of vulnerability of the production element to DDoS from the trained model; and
at least one memory configured to store data used by the at least one processor.
